(19) United States
(12) Patent Application Publication
(10) Pub. No.: US 2007/0289993 A1
(43) Pub. Date: Dec. 20, 2007

(54) SOAP AND DISPENSER WITH TIMING MECHANISM

(75) Inventor: Puneet Nanda, Cerritos, CA (US)

Correspondence Address: KNOBBE MARTENS OLSON & BEAR LLP, 2040 MAIN STREET, FOURTEENTH FLOOR, IRVINE, CA, 92614, US

(73) Assignee: Dr. Fresh, Inc., Buena Park, CA (US)

(21) Appl. No.: 11/735,236

(22) Filed: Apr. 13, 2007

Related U.S. Application Data
(60) Provisional application No. 60/791,686, filed on Apr. 13, 2006.

(51) Int. Cl. B67D 5/00; A47K 5/12; G04B 47/00; B67D 5/06

(52) U.S. Cl. 222/39; 222/192; 368/10; 222/23

(57) ABSTRACT

A liquid dispenser unit for storing and dispensing various liquids, such as soap, comprises a timing mechanism. The timing mechanism may be situated on an exterior or interior surface of the liquid dispenser unit. The timing mechanism, which may alternatively be positioned on the inside the container, is configured to alert a user that a particular time period has elapsed. This is particularly important for informing a user that he or she has performed an activity for a recommended minimum time period. The lights and/or other sensory devices of such liquid dispenser units may encourage and/or entice a user, especially young children, to perform an activity in the first place.

### CLAIM OF PRIORITY

This application claims benefit under 35 U.S.C. § 119(e) to U.S. Provisional Patent Application No. 60/791,686, filed Apr. 13, 2006 which is incorporated herein in its entirety by reference.

### BACKGROUND OF THE INVENTIONS

1. Field of the Inventions

The present invention relates dispensers products and, more particularly, to soap dispensers.

2. Description of the Related Art

Soap is used to destroy harmful microorganisms that may be found on a person's hands and other exposed skin portions. A person's skin may harbor many types of unwanted microorganisms, such as bacteria. These microorganisms contribute to both the initiation and progression of infections and other disease. Further, various lotions and other liquids provide therapeutic and other beneficial effects on the human skin. Moreover, other activities carried out in the bathroom, near a liquid dispenser unit, offer various hygienic benefits to the user. Typically, in order to maximize its effectiveness, a hand washing procedure or other activity carried out near a liquid dispenser unit must be performed for a minimum time period. In addition, some people often forget or are discouraged from performing such activities in the first place.

### SUMMARY OF THE INVENTION

In one embodiment, a liquid dispenser unit comprises a container for holding a dispensable liquid, a pump assembly hydraulically connected to the interior of the container and configured to dispense liquid to a location outside the liquid dispenser unit and a timing mechanism coupled to the container and/or the pump assembly. In some embodiments, the timing mechanism includes a timer, which is configured to determine a period of time, and a sensory device, which is configured to indicate when such a time period has elapsed. In one embodiment, the timing mechanism is attached to the top of the pump assembly. In another embodiment, the timing mechanism is attached to the container. In yet another embodiment, the timing mechanism is situated inside the container.

In some embodiments of the invention, the sensory device comprises one or more lights, vibrators, movements and/or auditory devices. In another embodiment, the pump assembly of the liquid dispenser unit comprises a leak-proof cap for securely containing the liquid within the container. In one embodiment, the dispensable liquid is liquid soap.

In another embodiment of the present invention, the liquid dispenser unit further comprises means for activating the timing mechanism. In one embodiment, the liquid dispenser unit further comprises means for activating the timing mechanism as the pump assembly is actuated to dispense the liquid from the container. In some embodiments, the period of time during which the sensory device is activated coincides with a minimum recommended hand washing period. In yet another embodiment, such a period of time is approximately 30 seconds.

### BRIEF DESCRIPTION OF THE DRAWINGS

FIG. 1 is a perspective view of a liquid dispenser unit comprising a timing mechanism according to an embodiment of the invention.

FIG. 2 is a block diagram of an embodiment of the timing mechanism.

FIG. 3 is a perspective view of a liquid dispenser unit comprising a timing mechanism according to another embodiment.

FIG. 4 is a top view of a liquid dispenser unit comprising a timing mechanism according to another embodiment.

FIG. 5A is a side view of a liquid dispenser unit comprising a timing mechanism according to another embodiment.

FIG. 5B is a side view of the liquid dispenser unit according to the embodiment of FIG. 5A.

FIG. 6 is a top plan view of an embodiment of a soap dispenser.

FIG. 7 is a perspective view of the embodiment of FIG. 6.

FIG. 8 is an exploded view of the embodiment of FIG. 6.

### DETAILED DESCRIPTION OF THE PREFERRED EMBODIMENTS

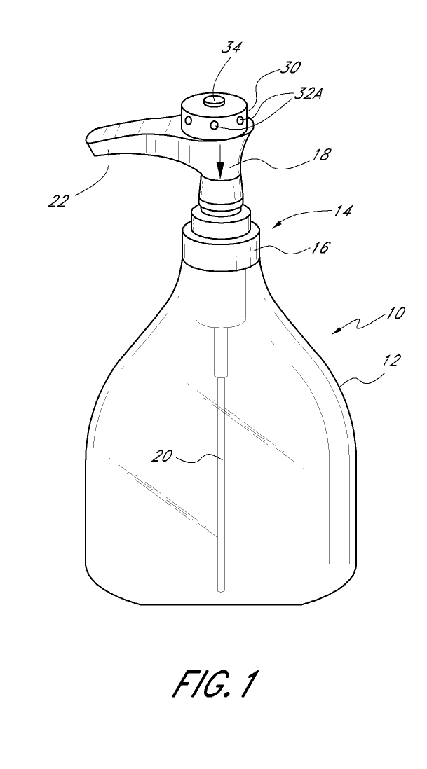

FIG. 1 illustrates a liquid dispenser unit 10 according to an embodiment of the present invention. In the illustrated embodiment, the unit 10 comprises a main container 12, a cap 16, a pump assembly 14 and timing mechanism 30. The container 12 is configured generally to hold liquid soap, lotion, shampoo, medicants or other liquids. The timing mechanism 30 is configured to provide feedback to a person who is using the liquid dispenser unit 10. For example, the timing mechanism 30 may inform a user of a recommended hand washing period. In some embodiments, the timing mechanism 30 is configured to alert the user after a set time period has passed (e.g., 30 seconds, 1 minute, etc.). However, in other embodiments, the timing mechanism 30 may be configured to permit a user to optionally adjust such a minimum time period.

In the embodiment of FIG. 1, the cap 16 can be threaded onto the container 12. This allows user to fill the dispenser unit 10 with a liquid of his or her choice. Further, the threaded connection allows for the optional refilling of the container 12. In other embodiments, other configurations can be used to connect the cap 16 to the container 12. For example, a snap fit or some other mechanical engagement method may be used. In other embodiments, the cap 16 can be bonded to the container 12 or integrally formed with the container 16. Although the container 12 may have any of a variety of shapes, in the illustrated embodiment, the container 12 has a generally oval cross section with tapering side walls culminating in a relatively wide base. The container 12 can be constructed of one or more materials, including plastic, glass, metal (e.g., stainless steel) or other suitable materials for holding liquids. For example, the container 12 can comprise a thermoplastic or polymeric material, such as ethylene acrylic acid, ethylene vinyl acetate, linear low density polyethylene, polyethylene terephtalate glycol, poly(hydroxyamino ethers), polyethylene terephtalate, polyethylene, polypropylene, polystyrene, cellulose material, mixtures thereof, and the like. The container 12 can be made by a thermoforming process, such as a stretch blow molding process or extrusion blow molding process. Preferably, the container 12 is transparent so that a person can see the enclosed contents. Those of skill in the art will recognize, however, that the container 12 can also be semitransparent or opaque.

As used herein, the term “container” is a broad term and is used in accordance with its ordinary meaning and may include, without limitation a bottle (typically of glass and/or plastic having a comparatively narrow neck or mouth), a bottle-shaped container for storing fluid (preferably a liquid such as liquid soap, though other liquids can be used including, without limitation, lotions, anti-microbial liquids, and water), etc. The terms “container” and “bottle” may be used interchangeably herein.

The pump assembly 14 can comprise a suction nozzle 20, an internal pump mechanism (not shown) and a discharge nozzle assembly 18. The discharge nozzle assembly 18 is preferably configured to also serve as a hand pump actuation device. In a preferred embodiment, a user is able to displace a small amount of liquid from the suction nozzle 20 and/or other hydraulically connected portions of the pump assembly 14 to the discharge nozzle 22 by pressing down on the discharge nozzle assembly 18. In such an embodiment, the discharge nozzle assembly 18 performs like a piston, as it is capable of being pressed down within the pump assembly. A spring (not shown) in the internal pump mechanism forces the discharge nozzle assembly 18 upwards to its original position. As the discharge nozzle assembly 18 ascends, liquid from the container 12 is drawn into the suction nozzle 20. Those of skill in the art will appreciate that other mechanisms, including other pump mechanism, can be used in modified embodiments to remove the liquid from the interior of the container 12.

The liquid dispenser unit 10 preferably includes one or more timing mechanisms. In FIG. 1, the timing mechanism 30 of the illustrated embodiment is positioned on top of the discharge nozzle assembly 18. For clarity, the timing mechanism is depicted as a simple cylindrical shape. Of course, the timing mechanism 30 can have any size, shape or configuration. The timing mechanism 30 can be configured to alert a user of the passage of particular time period. Such a feature is useful in encouraging a user to perform an activity (e.g., washing hands, brushing teeth, rinsing with mouthwash, etc.) for a recommended minimum time period. The timing mechanism may also be useful in encouraging users to carry out the activity in the first place. This may be especially helpful in enticing children in performing various periodic hygiene or health related activities.

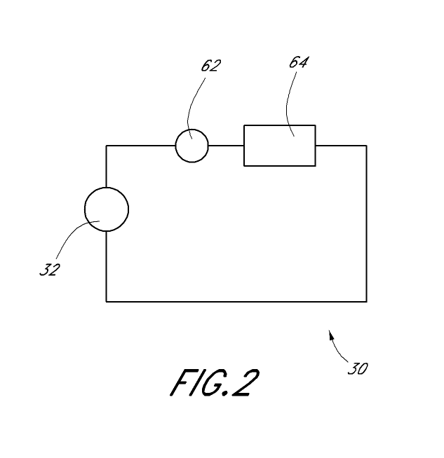

As shown schematically in FIG. 2, the timing mechanism 30 can include one or more of the following: a sensory device 60, a timing device 62 and a power supply 64. The sensory device 60 is preferably configured to generate an output that can be perceived by a person. For example, the sensory device 60 may comprise one or more lights, vibrators (e.g., a rotating unbalanced mass), auditory systems (e.g., speaker), articulating device (e.g., an articulating arm), visual display and the like. The timing mechanism 30 operates only for a predetermined time period in order to alert a person of the passage of such a time period. For example, one or more lights of a timing mechanism 30 may stay lit or may continue to flash for a time period deemed suitable for an adequate hand-washing procedure.

The power supply 64 provides power to one or more components of the timing mechanism 30. Preferably, the timing mechanism 30 is configured so that the power supply 64 provides power to both the one or more sensory devices 60 and the timing devices 62. The power supply 64 may include one or more batteries or another energy source device (e.g., small solar panel) to energize the different components of the timing mechanism 30. Of course, those of skill in the art will appreciate that not all embodiments of the timing mechanism 30 require a power supply 64 (e.g., certain mechanical timing devices).

The timing device 62 of the timing mechanism 30 may comprise a clock, a timer (e.g., mechanical timer, electric timer, etc.), and/or any other timing device. In some embodiments, initiation of timing cycle results in the activation of one or more sensory devices. With continued reference to FIG. 1, activation of the timing device causes the lights 32A to illuminate and/or flash. The lights 32A in FIG. 1 are powered by a power supply (not shown) in the form of a small battery. The lights 32A comprise one or more light emitting diodes (LED) or other suitable illumination device for capturing the attention of a user. The lights 32A will remain lit and/or flash until the predetermined time period has elapsed. The timing mechanism 30 can be configured to flash (preferably repeatedly) or provide continuous illumination to effectively alert a person. The effect created by the timing mechanism 30 may be further enhanced if the lights are configured to illuminate in different colors and/or flashed in a sequence or pattern.

In other embodiments, activating a timing cycle may have no effect until the predetermined time period has elapsed. Under such a configuration, activation of the timing mechanism 30 may prompt the lights 32A to illuminate and/or flash only after the predetermined timing period has expired. Regardless of how the timing mechanism 30 is configured to operate, activation or deactivation of the sensory device (e.g., light) indicates to the user that he or she has performed a particular task (e.g., washing of hands, rinsing with mouthwash, brushing of teeth, etc.) for a recommended period of time. Preferably, the timing device resets after completion of a timing cycle.

Once the sensory device is activated, the timing mechanism 30 starts measuring time. After a predetermined length of time has elapsed, the timing mechanism 30 deactivates (or activates) the sensory device, alerting the user that the requisite time period has expired. In some embodiments, the length of time measured by the timer is fixed and generally corresponds to a desirable duration for performing a particular activity. For example, the duration of the timing cycle may correspond to a recommended minimum time period for washing hands. Further, the sensory features of the timing mechanism 30 may be used to persuade a user to actually perform an activity in the first place. This is particularly well-suited for enticing or encouraging young children to wash their hands. In such embodiments, the sensory and the other decorative features of the liquid dispenser unit 10 become increasingly important.

The timing mechanism 30 may even be used to time activities completely unrelated to the dispensing of liquid from the dispending unit 10. For example, the timing feature provided by the dispensing unit 10 may be used for a variety of activities typically performed in a bathroom (e.g., brushing teeth, rinsing with mouthwash, flossing, etc.) Thus, a user may choose to activate the timing mechanism 30 of the dispensing unit 10 without actually dispensing liquid from it. In such embodiments, the dispensing unit 10 is simply used as a timer.

In some embodiments, a desired minimum time period for a hand washing or other task may be 10 seconds, 15 seconds, 20 seconds, 25 seconds, 30 seconds, 35 seconds, 40 seconds, 50 seconds and ranges encompassing such lengths of time. In one embodiment, the desired time period is about 30 seconds. In some embodiments, the time measured by the timer is adjusted to compensate for the time it takes to perform some related ancillary activity (e.g., turning on the facet, creating proper lather, etc.). For example, the timer can run for approximately 40 seconds, which includes 30 seconds for washing of hands and 10 seconds to turn on the water facet, adjust the water temperature and create the necessary lather. Additionally, the timing device of the timing mechanism 30 may include a controller that permits a user to optionally adjust the time associated with a particular activation period.

The timing device is preferably electronically driven. Alternatively, the timing mechanism may comprise a mechanically or otherwise driven timing device. For example, the timing device may comprise a windup clock, motion powered timing device or other suitable mechanical device. In FIG. 1, the timing mechanism 30 is configured to start measuring time when the user depresses a button 34. Alternatively, the timing mechanism 30 may include a switch or a tab that a user can actuate to start the timing process. The switch can be activated at any time, such as before, during or after the liquid has been removed from the dispenser unit 10. Preferably, the actuation device (e.g., button, switch, etc.) is activated contemporaneously with actuation (e.g., depression) of the discharge nozzle assembly 18. In some embodiments, the actuation device is preferably coupled to the discharge nozzle assembly 18, whereby operation to remove liquid from the dispenser unit 10 simultaneously activates the timing mechanism 30. In some embodiments, the actuation device can be disposed on top of the discharge nozzle assembly 18, whereby actuation of the nozzle assembly 18 necessarily engages the actuation device. However, the time cycle may commence simply when the user first touches the dispenser unit 10. In other embodiments, the timing mechanism 30 comprises a motion sensor, the activation of which initiates the beginning of the time period. In yet other embodiments, the timing cycle may be initiated using a voice activated sensor, a temperature sensor capable of detecting temperature changes (e.g., simply by touching a surface), an audio sensor (e.g., in response to a loud noise or particular words or phrases, etc.) or any other suitable mechanism.

The timing mechanism 30 can be attached to any suitable part of the dispenser unit 10. In FIG. 1, the timing mechanism 30 is attached to the top surface of the discharge nozzle assembly 18. Any known attachment mechanism or method can be used to connect the timing mechanism 30 to the dispenser unit 10. The timing mechanism 30 can be coupled to an adjoining surface of the dispenser unit 10 using adhesives, fasteners, mounting structures or any other attachment method or device. The dispenser unit 10 can even be manufactured as a single unit with the timing mechanism 30. The timing mechanism 30 can be permanently attached to one or more adjacent surfaces of the dispenser unit 10. However, in some embodiments, the timing mechanism 30 can be removably attached to the dispenser unit 10. Thus, dispenser units 10 can be configured so that timing mechanisms 30 can be optionally installed, removed and replaced as desired by a user.

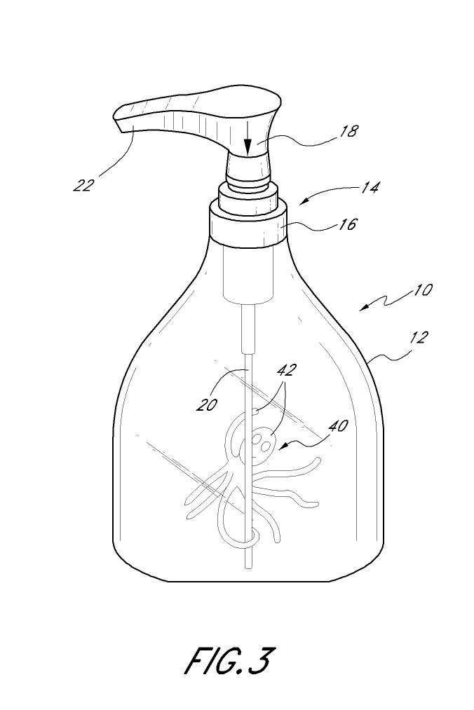

Preferably, the timing mechanism 30 is positioned so that the sensory device is easily visible to a user. The timing mechanism 30 can be positioned at other suitable locations on the dispenser unit 10. For example, the timing mechanism 30 may be positioned on the sidewall of the container 12, on the cap 16 or any other portion of the dispenser unit 10. Alternatively, the timing mechanism 30 may be positioned inside the container 12. For example, the timing mechanism 30 may be adhered to the interior surface of the container 12, to the bottom surface of the container 12, on the suction nozzle 20 or any other interior portion of the dispenser unit 10. FIG. 3 shows an octopus-shaped timing mechanism 40 attached to the suction nozzle 20. As depicted, the timing mechanism 40 is connected to multiple locations along the outer surface of the suction nozzle 20. The timing mechanism may even be embedded within the wall of the container 12.

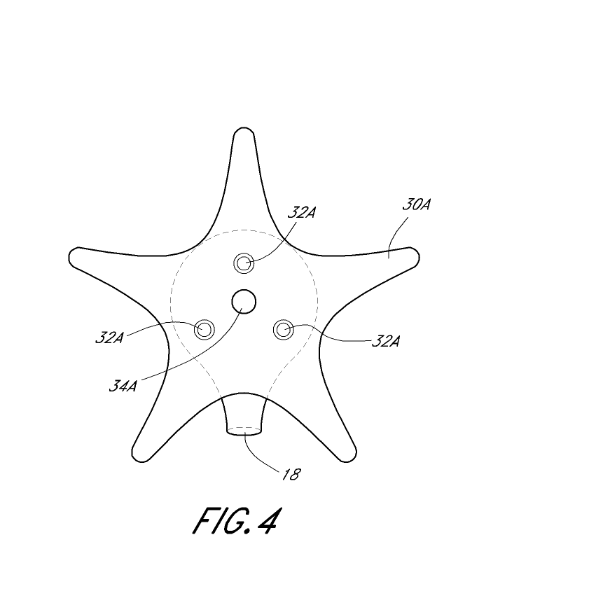

In FIG. 1, a timing mechanism 30 is positioned on top of the discharge nozzle assembly 18. As illustrated, the timing mechanism 30 has a generally cylindrical shape and covers only a portion of the discharge nozzle assembly 18. However, the timing mechanism 30 may have any shape and may cover more or less area of the adjacent discharge nozzle assembly 18 or other surface of the dispenser unit 10. For example, in one embodiment, the timing mechanism 30 is shaped like or coupled to a interesting figurine or sculpture. FIG. 4 is a top view of such an embodiment in which a starfish-shaped timing mechanism 30A situated on top of a discharge nozzle assembly 18. The depicted timing mechanism 30A is designed to removably wrap around the discharge nozzle assembly 18. This permits a user to optionally remove the timing mechanism 30A for cleaning, replacement or any other reason. For example, the illustrated timing mechanism 30A may be substituted for another design simply to satisfy the aesthetic desires of the user. In such a case, the various types of available timing mechanisms 30A are configured for similar attachment to the discharge nozzle assembly 18.

Further, various decorative features may be incorporated into a timing mechanism design to further enhance the overall aesthetic value of the liquid dispenser unit 10. For instance, the starfish embodiment may be made of a bright color (e.g., red) and may include one or more surface texture features (e.g., eyes, mouth, bumps, etc.). Preferably, the timing mechanism 30 is constructed of one or more durable materials capable of withstanding normal human contact and any elements to which it may be exposed (e.g., heat, water, liquid, steam, etc.). Thus, the starfish shaped timing mechanism 30 may be constructed of a waterproof soft rubber or plastic, a rust-proof metal (e.g., stainless steel) or any other suitable material. However, it will be appreciated by those of skill in the art that even less durable materials may be used.

With reference to FIG. 3, the timing mechanism 40 can form part of a sculpture (e.g., an octopus) that is situated on the interior of the container 12. Specifically, the timing mechanism 40 is connected to multiple locations on the surface of the suction nozzle 20. The octopus-shaped timing mechanism 40 is manufactured from one or more materials that are capable of withstanding the liquid contained within the dispenser unit 10. For example, the timing mechanism 40 may be plastic, rubber and/or any other suitable material. In the depicted embodiment, the sensory devices of the timing mechanism 40 are lights 42 that have been strategically positioned to coincide with the location of the octopus's eyes. In FIG. 3, the timing mechanism is activated by actuating the discharge nozzle assembly 18 in a downward position. Such an act simultaneously begins the timing cycle and delivers a portion of the liquid contents (e.g., liquid soap) of the dispenser unit 10 to the discharge nozzle 22. Once the timing mechanism 40 is activated, the lights 42 will preferably light and/or flash for the duration of the timing cycle. Preferably, the lights 42 or other sensory device remain activated for a duration that represents a minimum recommended length of time for carrying out a particular activity (e.g., washing hands, brushing teeth, etc.). Thus, a user may utilize such features of the timing mechanism 40 to ensure that he or she has property carried out an activity. Further, the sensory devices (e.g., lights 42) and the general aesthetic impression of the dispenser unit 10 may encourage or remind a user to perform an activity in the first place. For example, a child may choose to wash its hands primarily to see the lights of the timing mechanism 40 light up and/or flash. In a modified embodiment, the timing mechanism 40 can be positioned outside the container 12 (e.g., as in FIG. 1) with one on or more lights 42 operatively connected to the timing mechanism 40 and being position with in the container 12 (e.g., on or within the sculpture).

In other embodiments, activation of the timing device may initiate one or more other sensory devices. For example, in the dispenser unit 10 illustrated in FIG. 3, actuation of the discharge nozzle assembly 18 may cause the octopus-shaped timing mechanism 40 to perform one or more of the following non-limiting actions: light up/flash one or more lights 42, move its legs, rotate about the suction nozzle 20, make an sound, vibrate or perform any other action that may be perceived by a user. The use of the octopus-shaped timing mechanism is not required, and other timing devices can perform some or all of the actions described. The timing mechanism may be configured so that the sensory actions randomly or non-randomly vary from cycle to cycle. Alternatively, the user may choose what sensory actions are performed during the timing cycle. In other embodiments, the sensory actions performed may depend on one or more factors (e.g., how much pressure was exerted on the discharge nozzle assembly 18, the ambient temperature, other environmental factors, etc.).

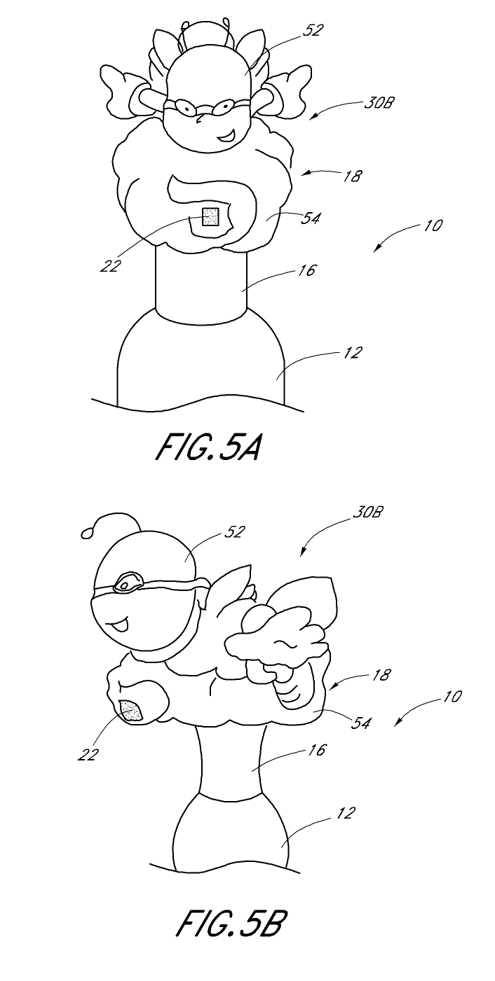

FIGS. 5A and 5B illustrate another embodiment of a liquid dispenser unit 10. The depicted timing mechanism 30B includes a sculpture 52 (e.g., cartoon character in the form of a firefly positioned on clouds 54). Preferably, the timing mechanism 30B is constructed of a single piece of plastic or another durable material and is painted with various bright colors to enhance the visual effect. However, the timing mechanism 30B may comprise multiple pieces and may be constructed of any suitable material. The timing mechanism 30B, which is situated above of the cap 16 of the dispenser unit 10, is configured to be pressed downward. Thus, the timing mechanism 30B also serves as the discharge nozzle assembly 18. As the timing mechanism 30B is pressed, liquid (e.g., liquid soap) within the container 12 is discharged through the discharge nozzle 22. Further, actuation of the timing mechanism 30B initiates the timing cycle and activates the one or more sensory devices. For example, lights which have been strategically positioned at the cartoon character's 52 eyes or antennas may light up or begin to flash. In some embodiments, the lights can be located within the dispenser 10, preferably visible through a transparent or translucent liquid contained therewithin. In some embodiments, the lights can be located on the outer surface of the dispenser. The cartoon character 52 may optionally begin to move its arms, legs or other body parts. In yet other embodiments, the timing device 30B may generate one or more audible sounds. Of course, those of ordinary skill in the art will appreciate that any combination of sensory devices, whether or not listed herein, may be used. Regardless, such sensory devices preferably remain active until a predetermined period of time has expired. Deactivation of the sensory devices informs the user that the time period has expired. The liquid dispenser unit 10 of FIGS. 5A and 5B is particularly well suited for capturing and maintaining the attention of young children.

Although the above-described embodiments primarily consists of a single timing mechanism 30, a plurality of timing mechanisms 30 may be used. For example, as mentioned above, a first timing mechanism 30 may be disposed on top of the discharge nozzle assembly 18, while a second timing mechanism 30 is positioned inside the container 12 (e.g., on the suction nozzle 20). The dispenser unit 10 may be provided with liquid (e.g., soap, lotion, etc.) already in the container 12. Alternatively, the dispenser unit 10 may be initially empty, requiring the user to fill the container 12 with a liquid of his or her choice. Further, the dispensing unit 10 is preferably provided with a removable cap to allow the container 12 to be emptied or filled at the discretion of the user.

In operation, under the embodiment depicted in FIG. 1, a user presses down on the discharge nozzle assembly 18 to dispense soap or other liquid through the discharge nozzle 22. By actuating the discharge nozzle assembly 18 in such a manner, a user also depresses the button 34 positioned on top of the discharge nozzle assembly 18. This initiates the timing cycle of the timing mechanism 30 and activates the lights 32 and/or other sensory device. The lights 32 and/or other sensory device remain activated (e.g., remain lit, flash, etc.) for a predetermined time period (e.g., 30 seconds). Once this time period has elapsed, the lights and/or other sensory devices will be deactivated, thus informing the user that the time period has expired. Alternatively, the timing mechanism 30 may be configured to permit the user to adjust this time period according to his or her preferences. The length of time during which the lights or other sensory devices remain activated may signify a minimum recommended period for performing a particular activity. Because the timing mechanism 30 is conveniently incorporated within the dispenser unit 10 design, a user does not need to use a separate time keeping device.

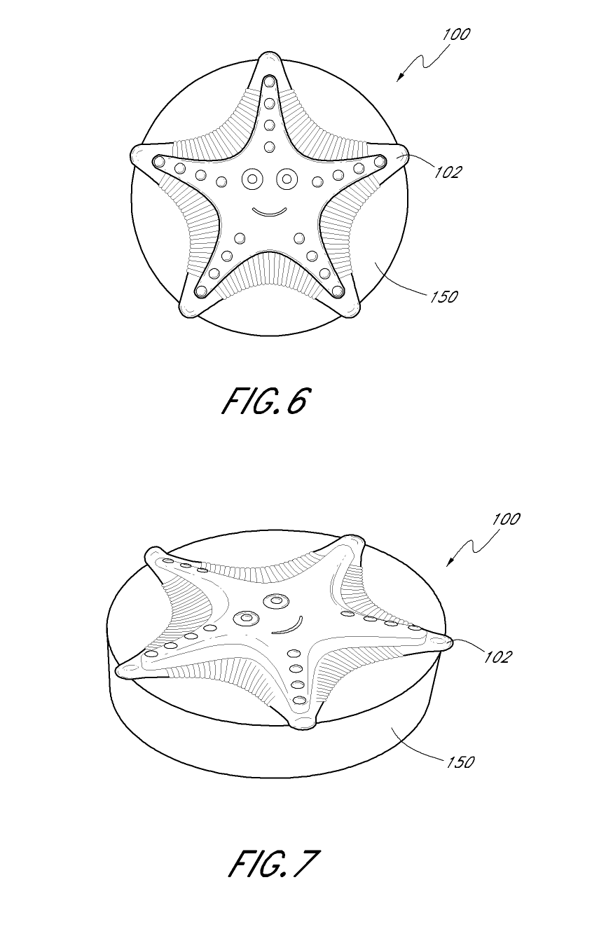

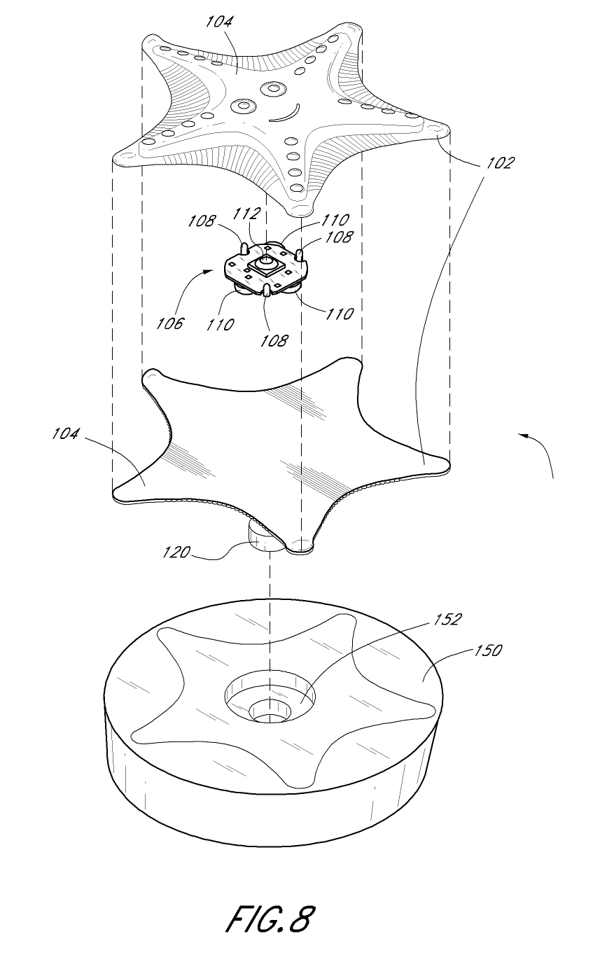

FIGS. 6-8 illustrate an alternative embodiment of a soap dispensing device 100. The device 100 can comprise a soap cake 150 and a decorative lighted member 102. The soap cake 150 can be of any suitable type of soap, including without limitation, anti-microbial, moisturizing, scented or scent-free, or any other suitable type of cleaning item. The surface of the soap 150 can be abrasive, slightly abrasive, smooth, textured, or otherwise shaped to aid in cleaning of the skin.

The lighted member 102 can be similar to the starfish embodiment 30 described above, as illustrated. In other embodiments, different cartoon items, such as fish, seahorses, or whales can be used. In still other embodiments, the lighted member 102 can be a physical object, such as a life-preserver, scrub brush, or any other appropriate, aesthetically pleasing representation. The lighted member 102 can be coupled to the soap cake 150 as seen in FIG. 8.

The lighted member 102 can be composed of two shell halves 104, as depicted, or can be a single unit. In some embodiments, the shell halves 104 are joined around the perimeter to produce a water-tight seal. In other embodiments, the periphery of the member 102 can be unsealed, and a seal instead disposed near a timing mechanism 106. The lighted member 102 can preferably be composed of a transparent or translucent material, such as a plastic or elastomer. The lighted member 102 can have a projection 120. The projection 120 can extend away from the lighted member 102, preferably toward the soap cake 150. As can be seen in the illustrated embodiment, the soap cake 150 can have a recess 152 sized and adapted to receive the projection 120. Accordingly, the lighted member 102 can be coupled to the soap cake 150. In other embodiments, different methods or coupling the lighted member 102 and the soap cake 150 can be employed. In some embodiments, the member 102 can be at least partially disposed within the soap cake 150. In other embodiments, rivets, composed of plastic, metal, or other materials, can be used to secure the member 102 to the soap cake 150. Preferably the member 102 is coupled such that as the soap cake 150 is eroded through repeated use, the coupling of the soap cake 150 to the member 102 remains until all or nearly all of the soap has been used.

The lighted member 102 can contain a timing mechanism 106. The timing mechanism 106 can comprise a plurality of power cells 110. The power cells can be solid-cell batteries or any other type of power cell as appropriate to activate the mechanism 106. Additionally, the timing mechanism 106 can comprise a plurality of lighting elements 108. In some embodiments, LED devices are used. In other embodiments, incandescent devices, or any other illuminating device can be disposed in the mechanism 106. In the illustrated embodiment, three power cells 110 and three lighting elements 108 are used, through more or fewer can be used as appropriate.

The timing mechanism 106 can be configured to receive a signal from an activation device 112. The activation device 112 can be any suitable sensor, including a motion sensor to detect use of the soap 100. Other devices 112 can include a pressure sensor, a pair of electrical terminals whose circuit, which can be completed with human contact or contiguous conductive fluid contact between the terminals. In some embodiments, submersion of the soap 100 into water to begin the washing process can activate the timing device. In other embodiments, the activation device 112 can be pressed from the top of the lighted member 102, activating the timing device.

The timing device 106 can operate as described above with reference to previous embodiments. In some embodiments, the timing device 106 can cause the lighting elements 108 to blink or maintain a steady light. The lighting elements 108 can remain active for any amount of time including, but not limited to, 15 seconds to two minutes. The frequency of blinking of the lights can remain constant or change over the illumination duration.

In other embodiments, the lighting elements 108 can be replaced by elements which create a tactile sensation, such as vibration or shaking. In some embodiments, the lighting elements 108 are replaced by elements which emit auditory signals, such as various tunes or melodies.

In use, the operator can begin the timing cycle through any applicable method, and use the soap cake 150 to cleanse their skin until the timing cycle completes and the lighting elements 108 cease operation. After complete use of the soap cake 150, once soap material is no longer coupled to the lighted member 102, the lighted member 102 can be used separately as a toy or decorative item.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein

What is claimed is:

1. A liquid dispenser unit comprising:
a container for holding a dispensable liquid;
a pump assembly hydraulically connected to the interior of the container and configured to dispense the liquid to a location outside the liquid dispenser unit; and
at least one timing mechanism coupled to at least one of the container and pump assembly, the timing mechanism including a sensory device and a timer, the timer being configured to determine a period of time and the sensory device configured to indicate when the period of time has elapsed.

2. The liquid dispenser unit of claim 1, wherein the timing mechanism is attached to the top of the pump assembly.

3. The liquid dispenser unit of claim 1, wherein the timing mechanism is attached to the container.

4. The liquid dispenser unit of claim 1, wherein the timing mechanism is situated inside the container.

5. The liquid dispenser unit of claim 1, wherein the sensory device comprises at least one selected from the following: light, vibrator, movement and auditory device.

6. The liquid dispenser unit of claim 1, wherein the pump assembly comprises a cap for containing the liquid within the container.

7. The liquid dispenser unit of claim 1, wherein the dispensable liquid is liquid soap.

8. The liquid dispenser unit of claim 1, further comprising means for activating the timing mechanism.

9. The liquid dispenser unit of claim 1, further comprising means for activating the timing mechanism as the pump assembly is actuated to dispense the liquid from the container.

10. The liquid dispenser unit of claim 1, wherein said period of time coincides with a minimum recommended hand washing period.

11. The liquid dispenser unit of claim 1, wherein said period of time is about 30 seconds.

12. A cleansing device comprising:
a cleansing material;
an timing device comprising an activation mechanism, a power source, and a signal device; and
an encapsulating shell at least partially surrounding the timing device and coupled to the cleansing material.

13. The cleansing device of claim 12, wherein the activation mechanism comprises a pressure switch.

14. The cleansing device of claim 12, wherein the activation mechanism comprises at least one electric terminal.

15. The cleansing device of claim 12, wherein the signal device comprises at least one illuminating device.

16. The cleansing device of claim 12, wherein the signal device comprises an auditory emitter.

17. The cleansing device of claim 12, wherein the signal device comprises a vibrating mechanism.

18. The cleansing device of claim 12, wherein the timing device is configured to activate the signal device for 60 seconds.

19. The cleansing device of claim 12, wherein the encapsulating shell is water-tight.

20. The cleansing device of claim 12, wherein the cleansing material is soap.
